(19) United States
(12) Patent Application Publication
(10) Pub. No.: US 2019/0351859 A1
(43) Pub. Date: Nov. 21, 2019

(54) KNEE AIRBAG ASSEMBLY

(71) Applicant: Toyoda Gosei Co., Ltd., Aichi (JP)

(72) Inventors: Michael Thomas Rhodes, Sainte, MO (US); Sara Anne Schumer, Perryville, MO (US); Roy P. Deutschmann, South Lyon, MI (US)

(21) Appl. No.: 15/983,600

(22) Filed: May 18, 2018

(51) Int. Cl. B60R 21/215; B60R 21/206

(52) U.S. Cl. CPC B60R 21/215; B60R 2021/21506; B60R 21/206

(57) ABSTRACT

An airbag cover includes a base panel portion, a side panel portion formed, and a cover panel portion. The cover panel portion is moveable relative to the base panel portion between a closed position and an open position. A latch is configured to releasably secure the cover panel portion to the side panel portion in the closed position. The latch is releasable upon the inflation of the cushion, such that the latch functions as a “tear seam” in the airbag cover. The entire airbag cover, including the base panel portion, the side panel portion, and the cover panel portion may be extruded as a single piece of plastic. The latch may provide a snap fit connection between the cover panel portion and the side panel portion.

### BACKGROUND

Knee airbags can significantly reduce the occurrence and severity of leg injuries in crashes. Typically, the knee airbag cushion is folded around the inflator. The inflator and cushion are protected and held in place by an airbag cover. The inflator, cushion and cover are secured to a case which is mounted in the vehicle.

### SUMMARY

An airbag cover includes a base panel portion and a side panel portion formed integrally with the base panel portion. A cover panel portion is also formed integrally with the base panel portion. The cover panel portion is moveable relative to the base panel portion between a closed position and an open position. A latch is configured to releasably secure the cover panel portion to the side panel portion in the closed position. The latch is releasable under force from the cushion, such that the latch functions as a “tear seam” in the airbag cover.

The entire airbag cover, including the base panel portion, the side panel portion, and the cover panel portion may be extruded as a single piece of plastic. The latch may provide a snap fit connection between the cover panel portion and the side panel portion. The latch releases upon the inflation of the airbag inside the airbag cover.

The entire airbag cover may be extruded and thus have a single, constant cross section throughout, with the exception of one or more openings through the base panel portion. The studs of the inflator may be inserted through the openings in the base panel portion for attachment to the case.

### BRIEF DESCRIPTION OF THE DRAWINGS

FIG. 1 is a perspective view of a knee airbag assembly according to a first embodiment.

FIG. 2 is an exploded view of the knee airbag assembly of FIG. 1.

FIG. 3 is a section view of the airbag cover of FIG. 2.

FIG. 4 is an enlarged perspective view of a portion of a cover of FIG. 3.

FIG. 5 is an enlarged view of a portion of the airbag cover of FIG. 3.

FIG. 6 illustrates one step of assembling the cushion and inflator into the cover to form the airbag assembly of FIG. 1.

FIG. 7 is a view similar to FIG. 6 of the fully assembled airbag assembly.

FIG. 8 is a view similar to FIG. 5 of a first alternate latch that could be used in the knee airbag assembly of FIG. 1.

FIG. 9 is a view similar to FIG. 5 of a second alternate latch that could be used in the knee airbag assembly of FIG. 1.

### DETAILED DESCRIPTION

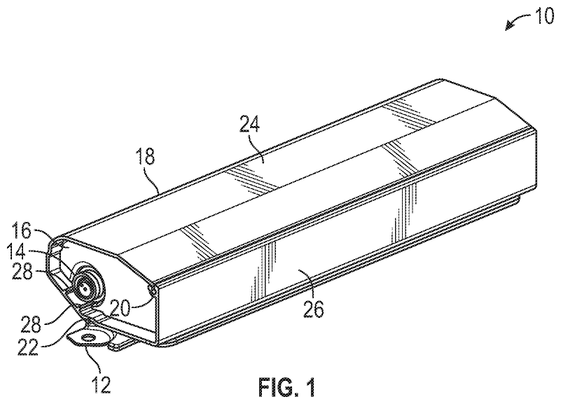

A knee airbag assembly 10 is shown in FIG. 1. The knee airbag assembly 10 includes a case 12 for securing the assembly 10 to the vehicle. An inflator 14 is disposed within a cushion 16, which in turn is wrapped within an airbag cover 18. The airbag cover 18 includes a latch 20 securing a cover panel portion 24 to a side panel portion 26 of the airbag cover 18. The airbag cover 18 also includes a base panel portion 22 secured against the case 12. Ribs 28 may be formed in the base panel portion 22 of the airbag cover 18.

The case 12 may be stamped metal. The cover 18 may be thermoplastic olefin or other suitable material.

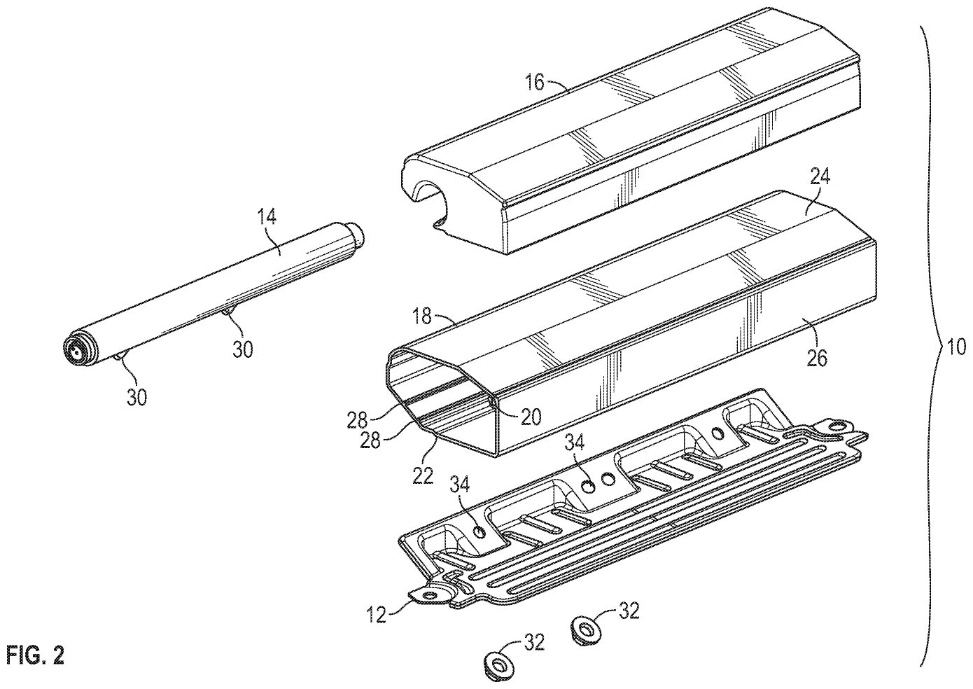

FIG. 2 is an exploded view of the airbag assembly 10 of FIG. 1. The airbag inflator 14 includes a pair of studs 30 extending radially from the inflator 14. The studs 30 are configured to extend through apertures 34 in the case 12 and to be secured with nuts 32.

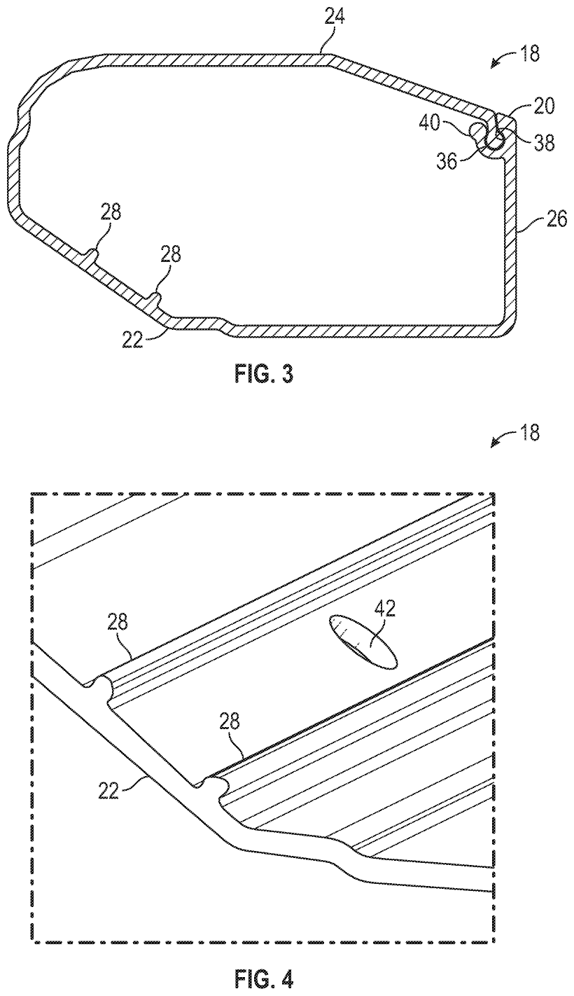

FIG. 3 is a section view through the airbag cover 18. The airbag cover 18 may be extruded as a single piece of plastic. As a result, the airbag cover 18 has a constant cross section, which is shown in FIG. 3. The cover panel portion 24 and the side panel portion 26 are formed integrally with the base panel portion 22 and ends thereof are connected by the latch 20. The latch 20 includes an enlarged portion 36, which may be formed on the cover panel portion 24, and a latch receiver portion 38, which may be formed at an end of the side panel portion 26. The latch receiver portion 38 is formed by a wall having an enlarged end 40. The latch 20 can be latched by snap fitting the enlarged portion 36 of the cover panel portion 24 into the latch receiver portion 38 on the side panel portion 26. In this manner, the enlarged portion 36 and the latch receiver portion 38 are interlocking portions. Alternatively, enlarged portion 36 could be formed on the side panel portion 26 and the latch receiver portion 38 could be formed on the cover panel portion 24.

Referring to FIG. 4, again, the cover 18 is extruded as a single piece of plastic and thus has a continuous cross section; however, one or more openings 42 are formed through the base panel portion 22 subsequent to the extrusion. In this example, a plurality of openings 42 (only one is shown) are formed between a pair of extruded ribs 28.

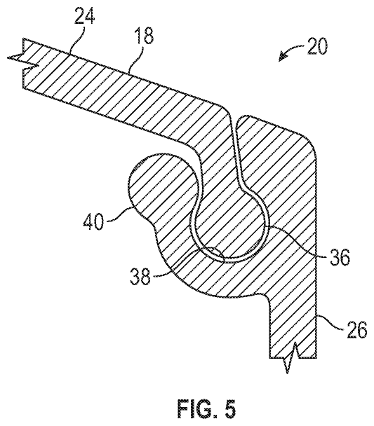

FIG. 5 is an enlarged view of the latch of FIG. 3. As shown, the enlarged portion 36 of the cover panel portion 24 is snap fit into the latch receiver portion 38 formed on the side panel portion 26. In this embodiment, the enlarged portion 36 is generally cylindrical. Relative to the immediately adjacent portion of the cover panel portion 24, the enlarged portion 36 is increased in dimension in both directions (above and below the cover panel portion 24). The latch receiver portion 38 includes a wall having the enlarged end 40, which is also somewhat cylindrical and which has an increased dimension in both directions relative to the wall.

The latch 20 can be snap fit together, and in the event of airbag inflation will easily release. In this way, the latch 20 is effectively a “tearseam,” and the cover 18 retention can be easily tuned by adjusting the sizes of the interlocking portions. Additionally, the interlocking portions can be formed wherever it is desired that the airbag cover separate (i.e. wherever it is desired that the “tearseam” be located”). Depending upon the particular configuration, the interlocking portions need not connect the cover panel portion to the side panel portion. The interlocking portions could connect a first cover panel portion to another cover panel portion or connect a side panel portion to the base panel portion, etc.

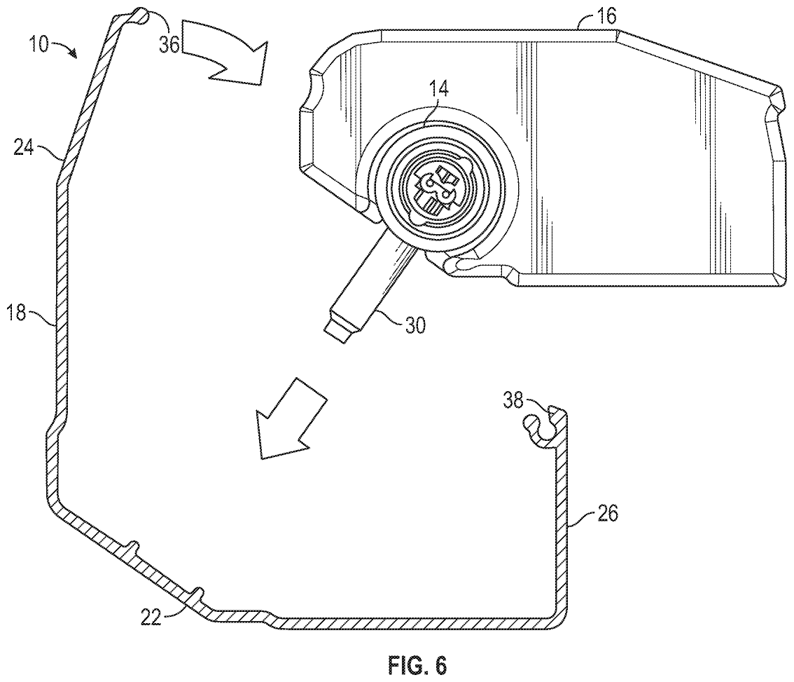

FIG. 6 shows a section view of the airbag cover 18 with the cover panel portion 24 in the open position. The cushion 16 is folded around inflator 14, which has the studs 30 projecting therefrom. The inflator 14 and cushion 16 are inserted into the cover 18, inserting the studs 30 through the openings 42 (FIG. 4). The cover panel portion 24 is then moved downward, inserting the enlarged portion 36 of the cover panel portion 24 into the latch receiver portion 38 for a snap fit connection, which also defines the tear seam of the airbag cover 18.

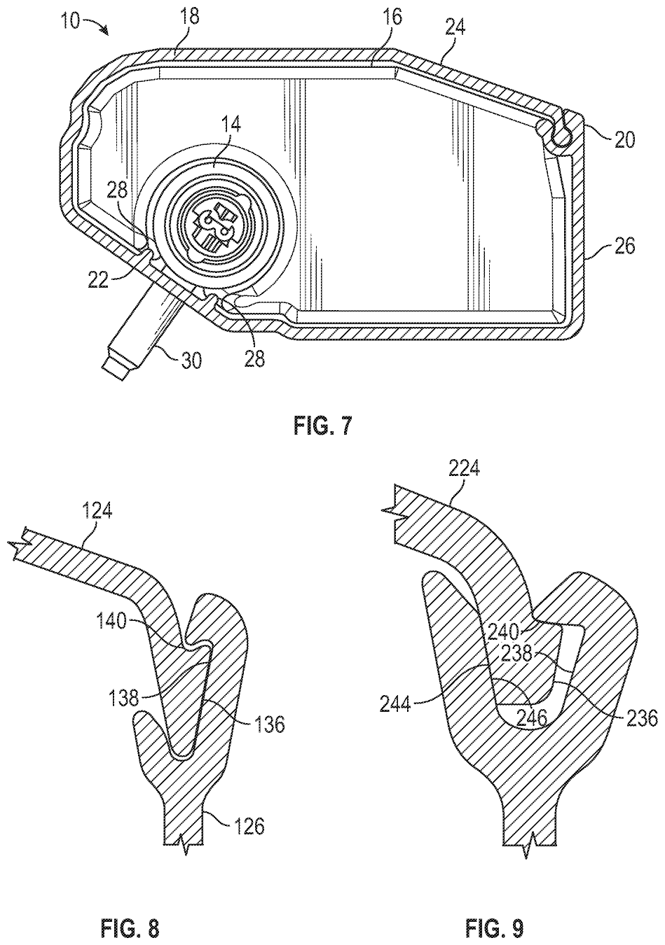

FIG. 7 is a view similar to FIG. 6 with the inflator 14 and cushion 16 assembled into the cover 18 and the latch 20 secured. The studs 30 extend outward through the base panel portion 22 of the airbag cover 18, between the extruded ribs 28 in the base panel portion 22. The inflator 14, cushion 16 and cover 18 subassembly can then be secured to the case 12, as in FIG. 1, such as by nuts 32 (FIG. 2). The contour of the cover 18 can be made to match the case 12 for a snug fit.

FIG. 8 is an enlarged view of an alternate latch 120 that could be used in the airbag assembly of FIG. 1, with cover panel portion 124 corresponding to cover panel portion 24 of FIG. 1, and with side panel portion 126 corresponding to side panel portion 26 of FIG. 1. As shown, the enlarged portion 136 of the cover panel portion 124 is snap fit into the latch receiver portion 138 formed on the side panel portion 126. The latch receiver portion 138 also includes an enlarged portion 140 that interlocks with the enlarged portion 136. In this embodiment, both enlarged portions 136, 140 have undercuts that engage one another to provide more potential retention than the FIG. 5 embodiment. The latch 120 can be snap fit together, and in the event of airbag inflation will easily release. In this way, the latch 120 is effectively a “tearseam,” and the cover retention can be easily tuned by adjusting the sizes of the interlocking portions. Again, the interlocking portions can be formed wherever it is desired that the airbag cover separate (i.e. wherever it is desired that the “tearseam” be located”). Depending upon the particular configuration, the interlocking portions need not connect the cover panel portion to the side panel portion. The interlocking portions could connect a first cover panel portion to another cover panel portion or connect a side panel portion to the base panel portion, etc.

FIG. 9 is an enlarged view of another alternate latch 220 that could be used in the airbag assembly of FIG. 1, with cover panel portion 224 corresponding to cover panel portion 24 of FIG. 1, and with side panel portion 226 corresponding to side panel portion 26 of FIG. 1. As shown, the enlarged portion 236 of the cover panel portion 224 is snap fit into the latch receiver portion 238 formed on the side panel portion 226. The latch receiver portion 238 also includes an enlarged portion 240 that interlocks with the enlarged portion 236. In this embodiment, each of the enlarged portions 236, 240 have one flat surface 244, 246 that abut one another to provide potentially less retention than the FIG. 5 embodiment. The latch 220 can be snap fit together, and in the event of airbag inflation will easily release. In this way, the latch 220 is effectively a “tearseam,” and the cover retention can be easily tuned by adjusting the sizes of the interlocking portions. Again, the interlocking portions can be formed wherever it is desired that the airbag cover separate (i.e. wherever it is desired that the “tearseam” be located”). Depending upon the particular configuration, the interlocking portions need not connect the cover panel portion to the side panel portion. The interlocking portions could connect a first cover panel portion to another cover panel portion or connect a side panel portion to the base panel portion, etc.

In accordance with the provisions of the patent statutes and jurisprudence, exemplary configurations described above are considered to represent a preferred embodiment of the invention. However, it should be noted that the invention can be practiced otherwise than as specifically illustrated and described without departing from its spirit or scope. For example, the example airbag assembly is a knee airbag assembly, but the inventive features described herein could also be used in other airbag assemblies, such as a side airbag, passenger airbag, etc. Further, although there are cost benefits to extruding the airbag cover, the airbag cover could also be injection molded, thermoformed, or formed from some other method. Alphanumeric identifiers on method steps are for ease of reference in dependent claims and do not signify a required sequence of performance of the method steps unless otherwise indicated specifically in the claim.

What is claimed is:

1. An airbag cover comprising:
a first panel portion; and
a second panel portion formed integrally with the first panel portion, the second panel portion movable relative to the first panel portion between a closed position and an open position, the second panel portion configured to be releasably secured the first panel portion to retain the second panel portion in the closed position.

2. The airbag cover of claim 1 wherein the first panel portion is a cover panel portion and wherein the second panel portion is a side panel portion.

3. The airbag cover of claim 2 further including a base panel portion integrally formed with the cover panel portion, wherein the base panel portion includes at least one opening therethrough for receiving a stud of an inflator therethrough.

4. The airbag cover of claim 3 wherein the base panel portion is between the cover panel portion and the side panel portion.

5. The airbag cover of claim 4 wherein the base panel portion, the side panel portion and the cover panel portion are extruded as a single piece of plastic.

6. The airbag cover of claim 1 wherein the first panel portion and the second panel portion are extruded as a single piece of plastic.

7. The airbag cover of claim 1 further including a latch releasably connecting the first panel portion and the second panel portion.

8. The airbag cover of claim 7 wherein the latch provides a snap-fit connection between the first panel portion and the second panel portion.

9. The airbag cover of claim 8 wherein the latch is configured to release upon the inflation of an airbag inside the airbag cover.

10. The airbag cover of claim 7 wherein the latch includes a first interlocking portion and a complementary second interlocking portion.

11. The airbag cover of claim 10 wherein the first interlocking portion is an enlarged portion and wherein the second interlocking portion is a latch receiver capable of receiving the enlarged portion therein.

12. The airbag cover of claim 11 wherein the enlarged portion is capable of snap-fitting into the latch receiver.

13. The airbag cover of claim 11 wherein the enlarged portion is extruded along an outer edge of one of the cover panel portion and the side panel portion and wherein the latch receiver is extruded along an outer edge of the other of the cover panel portion and the side panel portion.

14. The airbag cover of claim 13 wherein the first panel portion is a cover panel portion and wherein the second panel portion is a side panel portion, the airbag cover further including a base panel portion between the cover panel portion and the side panel portion, wherein the base panel portion, the side panel portion and the cover panel portion are extruded as a single piece of plastic.

15. An airbag assembly including the airbag cover of claim 1, the airbag assembly further including an inflator and a cushion within the airbag cover.

16. The airbag assembly of claim 15 wherein the inflator includes at least one stud extending through an opening through the airbag cover and secured to a case.

17. The airbag assembly of claim 16 wherein the airbag assembly is a knee airbag assembly.

18. A method for assembling an airbag assembly including the steps of:
a) placing a cushion adjacent an airbag cover;
b) wrapping the airbag cover around the cushion; and
c) releasably securing the airbag cover around the cushion by connecting a first interlocking portion of the airbag cover to a second interlocking portion of the airbag cover.

19. The method of claim 18 wherein the airbag cover is an extruded single piece of plastic, including the first interlocking portion and the second interlocking portion.

20. The method of claim 18 further including the step of placing an inflator adjacent the airbag cover and in said step b) wrapping the airbag cover around the inflator.

21. The method of clam 20 wherein said step c) includes snap-fitting the first interlocking portion to the second interlocking portion.

22. The method of claim 20 further including the step of inserting studs formed on the inflator through openings formed through the airbag cover and securing the studs to a case.

23. The method of claim 18 wherein the first interlocking portion includes an enlarged portion and wherein the second interlocking portion includes a latch receiver for receiving the enlarged portion.

24. The method of clam 18 further including the step of extruding the airbag cover prior to said step a).
